(19) United States
(12) Patent Application Publication
(10) Pub. No.: US 2009/0138673 A1
(43) Pub. Date: May 28, 2009

(54) INTERNAL MEMORY MAPPED EXTERNAL MEMORY INTERFACE

(75) Inventors: Thomas James WILSON, Pleasanton, CA (US); Yutaka Hori, Cupertino, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(73) Assignee: Apple Inc., Cupertino, CA (US)

(21) Appl. No.: 11/946,811

(22) Filed: Nov. 28, 2007

(51) Int. Cl. G06F 12/00

(52) U.S. Cl. 711/211; 711/E12.001

(57) ABSTRACT

This is directed to allowing a processor of a device to use ordinary internal memory read and write instructions that read and write to external memory. Thus, the complexities associated with the existing methods of accessing external memory can be avoided. More specifically, an address space portion that does not correspond to any existing internal memory can be defined as associated with an external memory. When access to the external memory is required, the processor can simply issue ordinary internal memory read/write instructions that are addressed to the above mentioned address space. An interface controller can receive the read and write instructions and communicate with an external memory in order to execute them. The controller can then send a result back to the processor (if required) in the format that would be expected from an internal memory access operation.

### FIELD OF THE INVENTION

This relates to devices utilizing external memories in general, and more specifically to using internal memory instructions for communication with external memories.

### BACKGROUND OF THE INVENTION

Various existing electronic devices use a processor and a memory. The processor can execute instructions stored in the memory and process data stored in the memory. The processor usually accesses memory through an internal bus and references memory to be accessed using a single memory address space. Since memory access tends to occur very often, in many existing electronic devices the bus is designed to provide fast memory access based on simple instructions.

Many electronic devices interact with external memories. Currently most popular external memories are FLASH based (such as, e.g., MEMORY STICK, COMPACT FLASH, SMART MEDIA, etc.) However other types of external memories can be used, such as volatile memory modules, hard drive modules, or floppy disk or other removable media modules. External memories can hold various data needed by the electronic devices, such as, for example, music, pictures video, etc.

External memories can be connected to the electronic device utilizing an external interface. For example a Serial Port Interface (SPI), FireWire or Universal Serial Bus (USB) interface could be used. The interface could include an interface module located at the electronic device which is connected to the processor through the bus. The processor can access the external memory by sending commands through the bus to the interface in order to program the interface to communicate with the external memory according to a predefined interface protocol.

However, the interface protocol is often comparatively complex. This is especially true when it is compared with the protocol used to access internal memory. Accordingly, the interface protocol may require multiple communications and one or more interruptions of the processor for each unit of data stored or retrieved. This would in turn require that relatively complex software be executed at the processor in order to access external memory.

### SUMMARY OF THE INVENTION

This is directed to allowing a processor of a device to use ordinary internal memory read and write instructions to read and write to external memory. Thus, the complexities associated with the existing methods of accessing external memory can be avoided.

More specifically, an address space portion that does not correspond to any existing internal memory can be defined as associated with an external memory. When access to the external memory is required, the processor can simply issue ordinary internal memory read/write instructions that are addressed to the above mentioned address space. An interface controller can receive the read and write instructions and communicate with an external memory in order to execute them. The controller can then send a result back to the processor (if required) in the format that would be expected from an internal memory access operation.

### BRIEF DESCRIPTION OF THE DRAWINGS

FIG. 1 is an illustration of an exemplary SPI connection.

FIG. 2 is an illustration of an exemplary device connected to a Flash memory through an SPI interface.

FIG. 3 is a diagram of an exemplary Flash memory read command and response pair.

FIG. 4 is a diagram of an exemplary electronic device according to one embodiment of this invention.

FIG. 5 is a diagram of an exemplary memory address space of an electronic device according to one embodiment of this invention.

FIGS. 6A and B are a flow chart showing an exemplary method for performing an external memory access according to one embodiment of this invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

This relates to providing an external memory interface which allows for accessing external memory using internal memory access instructions and addressing.

Although embodiments of the present invention are described herein in terms of FLASH memory accessed through the SPI interface, it should be understood that the present invention is not limited to these types of memory and this interface, but is generally applicable to all electronic devices that utilize an internal and external memory.

Embodiments of the present invention improve the efficiency and reduce the complexity of communications between an electronic device and an external memory attached to the electronic device. Various types of external memories can be used in conjunction with the present invention. For example, FLASH memories, such as, e.g., MEMORY STICK, COMPACT FLASH, SMART MEDIA, etc. can be used. Additionally, other types of external memories, such as volatile memory modules, hard drive modules, floppy disk or other removable media modules can be used. Furthermore, various interfaces such as, for example, Serial Port Interface (SPI), FireWire or Universal Serial Bus (USB) can be used. Furthermore, the electronic device of the present invention can be any electronic device that utilizes external memory such as, for example, a personal computer, a notebook computer, another type of portable computer, a digital camera, a digital video recorder, a voice recorder, a portable telephone, a PDA, a portable music and/or video player, an e-book reader, a video game console, etc.

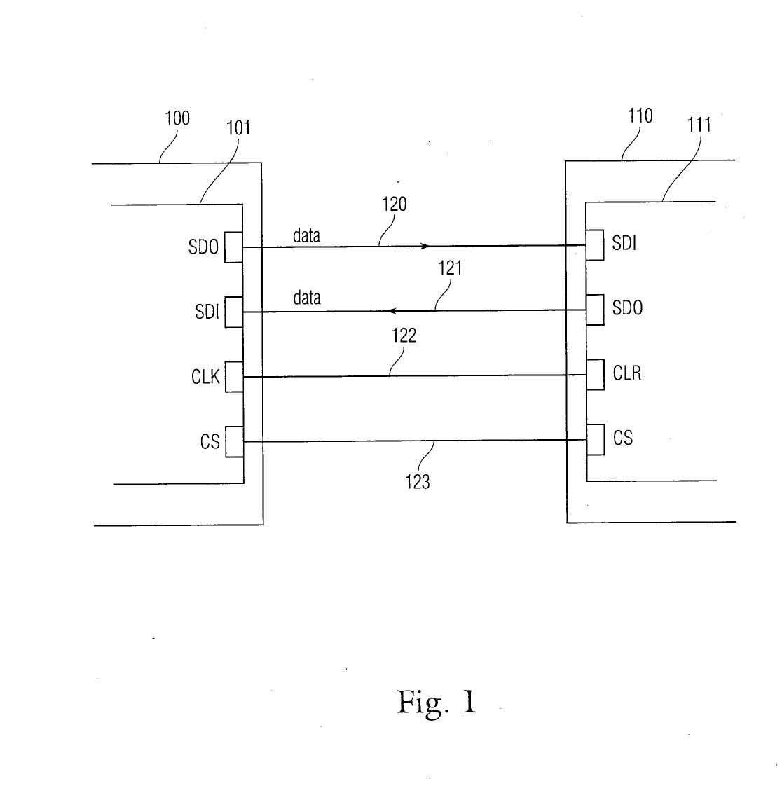

FIG. 1 is an illustration of two devices (devices 100 and 110) are connected through a SPI interface. Device 100 can be an electronic device and device 101 can be a memory (such as a FLASH memory).

Each device can include a SPI interface module (101 and 111, respectively) which handles communications over in accordance with the SPI protocol. Each interface module can include various electronics for transmitting and receiving data and other signals required by the SPI protocol as well as the physical plugs for a cable connecting the two devices.

A SPI interface may feature two data wires. The data wires may be used to transfer data in opposite directions. Thus, data wire 120 may transfer data from device 100 to device 110 while data wire 121 can transfer data from device 121 to device 120. Accordingly, data wire 120 can be connected to a serial data out (SDO) port of interface 101 and a serial data in (SDI) port of interface 111, while data wire 121 can be connected to an SDI port of interface 111 and an SDI port of interface 101. This can allow for two streams of data to be simultaneously transmitted over the interface.

The SPI protocol can require that one device connected to an SPI interface be designated as a master, while the other connected device is designated as a slave (in some cases there may be multiple slaves connected). The master can provide overall control over the transmission of data; it can, for example, determine when transmission starts and stops. In FIG. 1, interface 101 is the master.

Wire 122 can be used to transmit a clock signal. The clock signal can be generated by the master and sent to the slave. The clock signal sent over wire 122 can be referred to as an SPI clock or an SCLK to distinguish it from other clocks that may be generated within interfaces 101 and 111 and devices 100 and 110. The data sent through wires 120 and 121 can be serialized and synchronized with the SCLK signal. Thus, wires 120 and 121 may each carry a binary signal which defines a plurality of bits each new bit being signified by a change in the SCLK signal.

Wire 123 can be used to carry a chip select signal. The chip select signal is also generated by the master and sent to the slave(s). When two devices are connected (as in FIG. 1), the chip select signal can be used to activate and deactivate the connection. In other words, the connection can be considered to be switched off until the master indicates that it is active by toggling the chip select signal. When multiple devices are present, multiple chip select signals can be used by the master to determine which slave the master is communicating with by activating and deactivating various connections.

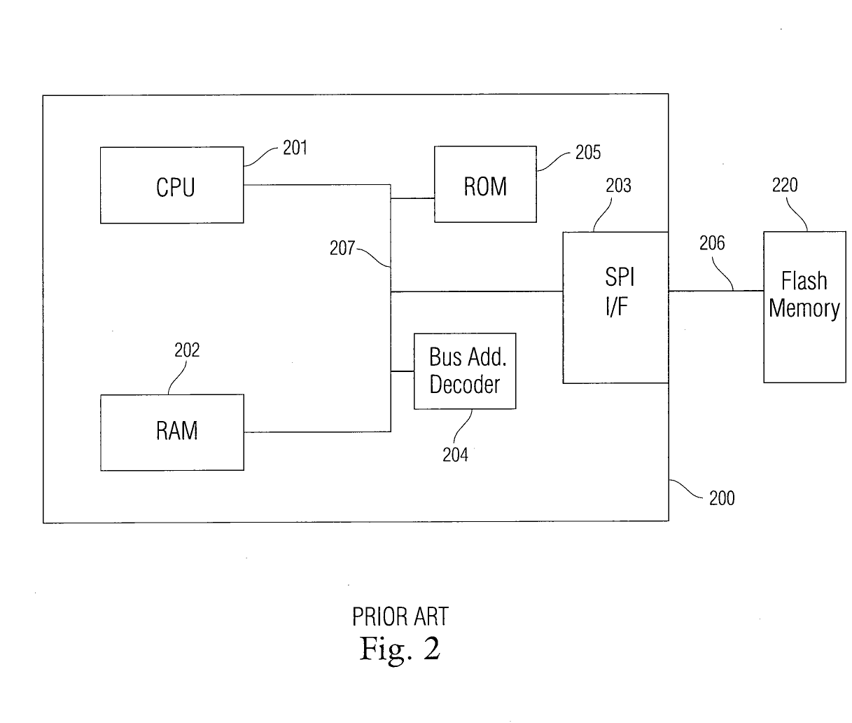

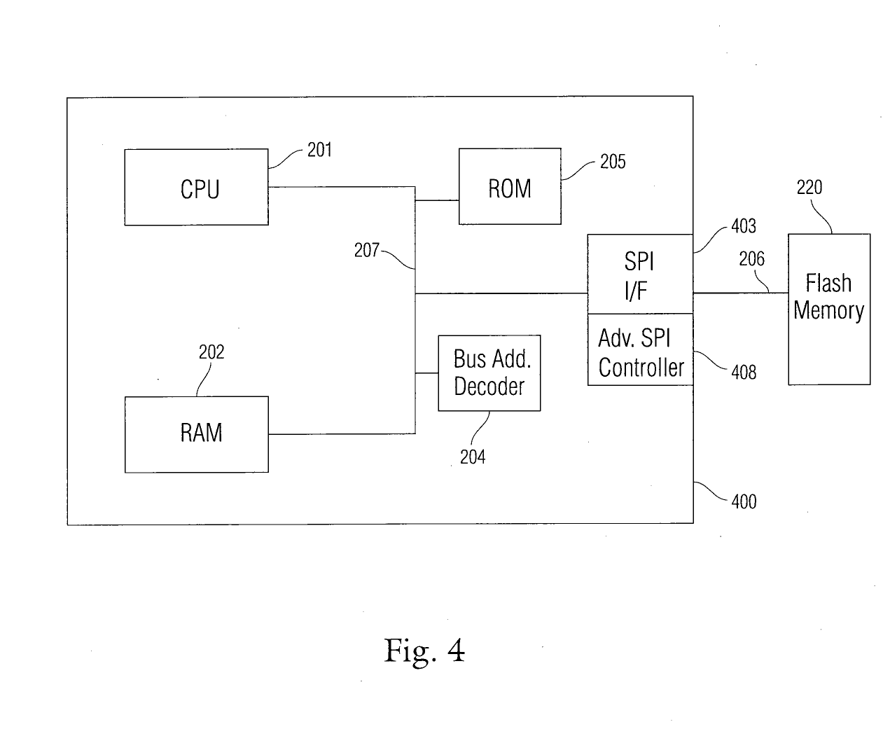

In embodiments of the present invention, device 100 can be an electronic device (such as a mobile telephone, computer, etc.), while device 110 can be an external memory (e.g. a Flash memory) attached to the electronic device. This type of configuration is discussed in more detail with reference to FIGS. 2 and 4 below.

FIG. 2 is a diagram of an exemplary electronic device 200 connected to a Flash memory 220 through a SPI interface. Device 200 can include a CPU 201, random access memory (RAM) 202, read only memory (ROM) 205, and a SPI interface 203 that provides a connection to an external Flash memory 220 through a SPI compatible connection 206. Connection 206 can include a couple of connectors, a cable, and/or any other SPI compatible connection.

The CPU can be connected to elements 202, 203 and 205 through a bus 207. The CPU can issue instructions on the bus in order to communicate with devices 202, 203 and 205.

In order to communicate with the internal memory (RAM 202 and ROM 205), the CPU can issue a relatively simple memory load or store instruction. The instruction can include a command portion indicating whether a load or store is desired, an address portion indicating the address where data is to be loaded from or stored to and (if it is a store instruction) a data field indicating the actual data to be stored. The address portion can include a device specific address of the memory to be accessed. Bus address decoder 204 examines the instruction and based on the address portion forwards it to an appropriate memory (such as, e.g., RAM 202 or ROM 205). The address decoder can also forward the instruction to an appropriate portion of memory (e.g., one or multiple memory chips which form RAM 202) based on the address portion. Furthermore, the address decoder can forward read/write instructions to the SPI interface 203, if these instructions are associated with addresses belonging to a predefined address space associated with the SPI interface. Thus, the processor can communicate with the SPI interface by reading and/or writing data to SPI interface buffers.

In order to read or write data to and from Flash memory 220, the processor may need to perform a more complex action. The processor may need to program SPI interface 203 by performing multiple successive operations and wait for the SPI interface to communicate a command to the Flash memory based on the programming. More specifically, in order to read or write from the Flash memory the processor can write one or more (usually more than one) bytes to the SPI interface, the bytes being the programming of the SPI interface which can cause it to send a desired command to the Flash memory.

Having received a command from the SPI interface, the Flash memory can perform a read or write operation according to the command and send a response to SPI interface 203. (Naturally the Flash memory can use its own SPI interface to communicate with SPI interface 203). Once it receives the response, SPI interface 203 can interrupt the CPU. An interruption can cause the CPU to stop its current programming in order to attend to the cause of interruption—i.e., the SPI interface. The CPU can then obtain the Flash memory response from the SPI interface. At this point the CPU may need to store that data in memory (e.g., RAM 202). While it is possible that the CPU can store the data in its registers and process it immediately, that may not be the case in practice. Since the CPU was interrupted, its interruption handling routines may cause it to return to the program it was performing before the interruption as soon as possible. Therefore, the CPU may be unable to process the incoming data and may instead need to store it in memory.

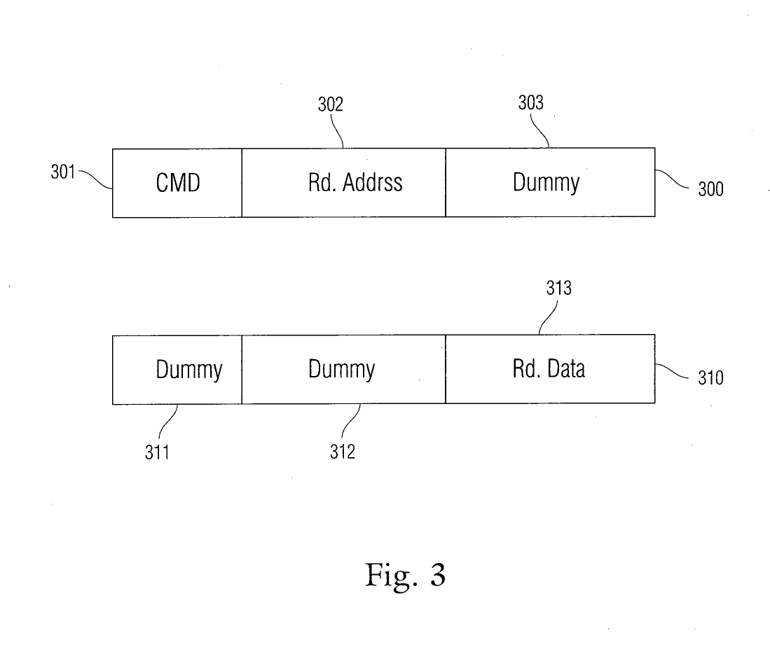

FIG. 3 shows an exemplary Flash memory command and response pair. Command 300 can be a command to read an address from the Flash memory. It can include three portions—a command portion 301 indicating the type of command (e.g., read), an address portion 302 indicating the address of the Flash memory the command is to be performed at, and a third unused (dummy) portion. Each portion can be a byte in length. Alternatively, some or all portions can be longer. For example, for an external memory device of a larger capacity, the address portion (302) can comprise multiple bytes. In order to program the SPI interface to transmit command 300, the CPU may need to store the entire command into the SPI interface. For that purpose, the CPU may need to perform several actual bus write operations, in order to store each byte.

Response 310 can be sent from the Flash memory to the SPI interface. The SPI interface can interrupt the processor as a result (as discussed above). Response 310 can also include three portions. These can include two dummy portions (311 and 312) and one portion (313) that includes the data read from the Flash memory as a result of command 300. Again the various portions can each be a byte long or longer. For example if the Flash memory stores data based on a word size larger than a byte, portion 313 can comprise multiple bytes. The processor may need to save the three portions of response 310 by performing multiple read and store operations. While two of the portions of response 310 are not needed, the processor may be unaware of that as it may be processing response 310 as a result of an interrupt and thus may not have the proper context to actually know what data is expected in bytes 311 and 312.

It can be seen that the existing techniques for communicating with an external Flash memory can be relatively burdensome. They can require that multiple instructions to be executed by the processor and can cause interruptions after each read and write operation. This can generally slow down execution of software and require software of relatively high complexity when frequent communication with external memory is desired.

Embodiments of the present invention can address these issues. FIG. 4 is a diagram of an exemplary electronic device 400 according to embodiments of the present invention. Device 400 can be similar to device 200 of FIG. 2. However, device 400 can include a modified SPI interface 403. The modified SPI interface can include an advanced SPI controller 408. The advanced SPI controller can provide advanced functionality in accordance to embodiments of the present invention. More specifically, the advanced SPI controller can allow the CPU to treat external Flash memory 220 as an internal memory.

Accordingly, a portion of the memory address space of device 400 can be associated with an external Flash memory. Embodiments of the present invention can allow the CPU to use ordinary internal memory read and write instructions that reference that space to access the external Flash memory. Thus, the complexities associated with the existing methods of accessing external memory can be avoided.

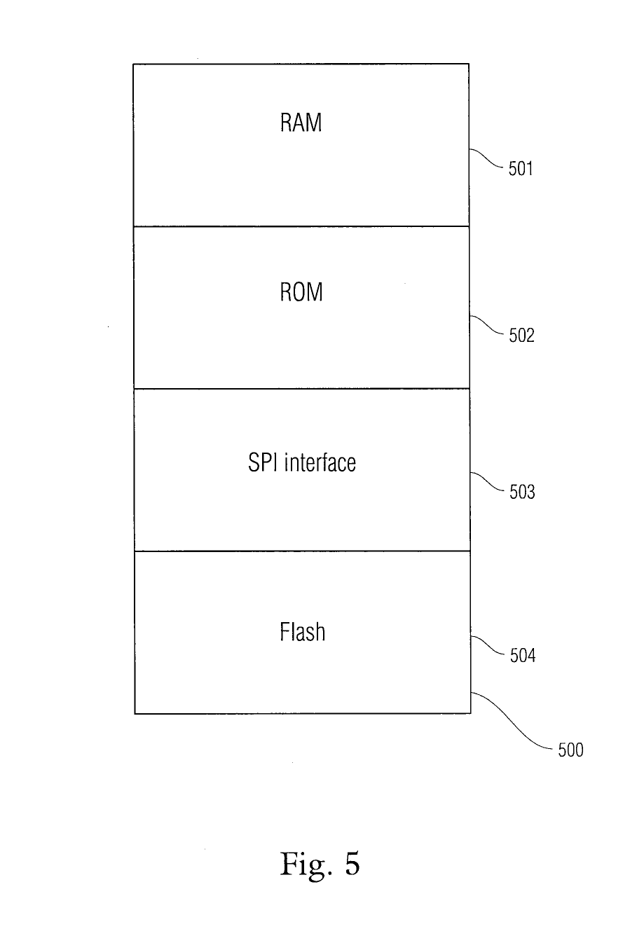

FIG. 5 is a diagram of an exemplary memory address space of an electronic device according to embodiments of the present invention. Address space 500 can define a plurality of allowable memory addresses for device 400. Portion 501 of the address space can be associated with RAM 202. Portion 502 can be associated with ROM 205. Portion 503 can be associated with the SPI interface 403. More specifically, this portion can be associated with one or more internal buffers of the SPI interface and can be used to program the SPI interface according to the prior art method discussed above in the context of FIG. 2. This method can also be utilized by embodiments of the present invention when devices that are not external memories are connected to the SPI interface (or when devices that are external memories but are not compatible with the present invention are connected).

Portion 504 can be associated with the Flash memory. Embodiments of the invention can allow the CPU to read and write to address space 504 as if it represents internal memory. However, address space 504 need not represent an internal memory but may instead represent respective addresses of the external Flash memory. It should be noted that address space 504 can represent the Flash memory for the purposes of device 400 (and, more specifically, CPU 201), and can thus includes device specific addresses. The actual addresses that Flash memory 220 uses to address its own data (i.e., the Flash memory specific addresses) need not be part of address space 504.

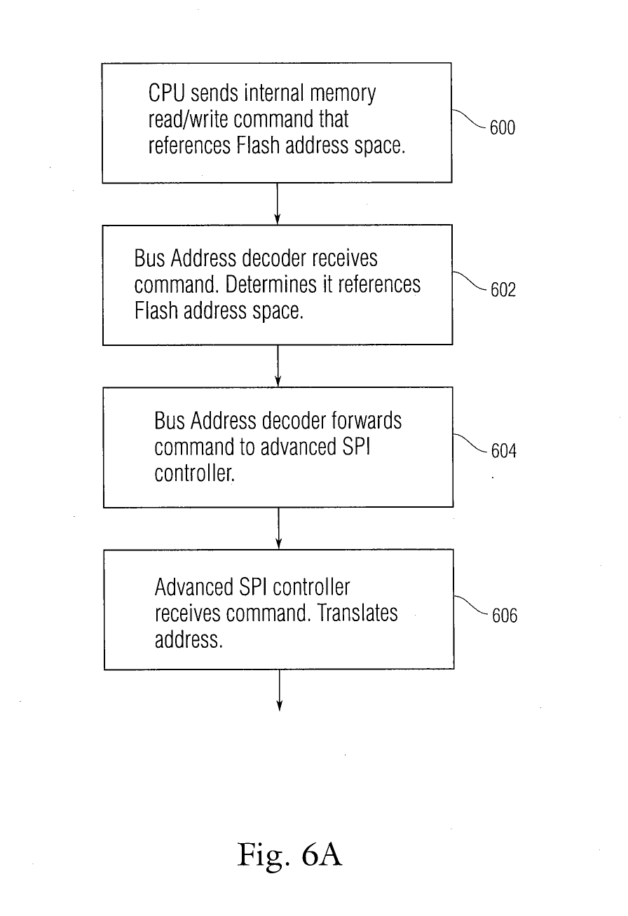

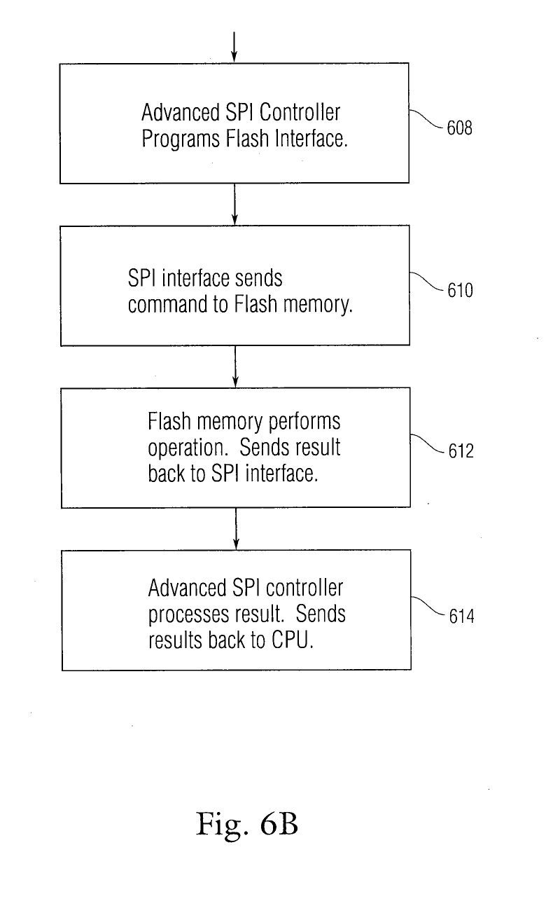

FIGS. 6A and B are a flow chart showing a method of accessing an external memory according to embodiments of this invention. Referring to FIG. 6A, if the CPU needs to read and write to the Flash memory, it can place an ordinary internal memory read or write command on the internal bus 207 (step 600). The command can include an address within address space 504. Bus address decoder 204 can receive the command and determine that it references address space 504 (step 602). Based on that determination, the bus address decoder can forward the command to the SPI interface in step 604 (and more specifically, to the advanced SPI controller within that interface).

The advanced SPI controller can receive the command and translate the address it references from address space 504 to a Flash memory specific address (step 606). A Flash memory may utilize a local address space that can be different than the address space 504 that is reserved for the Flash memory by the electronic device. In other words, the numerical values of addresses of the Flash memory can different than those of the addresses associated with the Flash memory by electronic device 400 (i.e., address space 504). Therefore, the advanced SPI controller may need to translate incoming addresses from the address space of the device 400 to an address space associated with the actual Flash memory 220. This translation can be performed in various ways. For example one or more leading digits (the digits can be binary, decimal, hexadecimal, etc.) of the device specific address produced by the CPU (i.e., the address from address range 504) can be removed to produce a Flash memory local address. Alternatively, a predefined offset can be subtracted from the device address in order to obtain the Flash memory address.

At step 608, the advanced SPI controller can program the SPI interface to perform the command that was received from the bus. For example, if the command received from the bus is a read command, the advanced SPI controller can store portions 301-303 of FIG. 3 in the SPI interface. If the received command is a write command, the advanced SPI controller can store a similar set of data that define a write command for the Flash memory. The advanced SPI controller can use the Flash memory specific address obtained in step 606.

Once programmed, the SPI interface can send a command to the Flash memory (step 610). Again, this can be a read or write command which includes the Flash memory specific address obtained in step 606. At step 612, the Flash memory receives the command sent in step 610, performs the necessary operation and sends back a result to the SPI interface. The result can be the data that was to be read (if a read command was sent) or, if a write command was sent, the result can be an acknowledgement that the write command was executed. In some embodiments a result need not be sent (especially in the context of a write operation).

In step 614, the advanced SPI controller receives the result and processes it. The processing may involve changing the format of the result from a format that is associated with the Flash memory to a format that is associated with an internal memory of device 400. For example, if the result is of the type of result 310 of FIG. 3, processing the result can involve removing the two dummy portions 311 and 312. After processing the result, the SPI can send it back to the CPU by placing it on the bus. Since after processing the result is in the format that would be expected from internal memory (such as RAM 202 or ROM 205), the entire operation can appear to the CPU as an ordinary internal memory access operation. In some cases (especially in the context of a store operation), no result need be sent back to the processor.

Thus the advanced SPI controller can allow for a CPU to access an external Flash memory in the same manner it accesses internal memory. It should be noted that the steps of FIGS. 6A and B can differ for alternative embodiments. For example, some embodiments may require an additional step of error checking communications between the SPI controller and the external Flash memory.

The method of FIGS. 6A and 6B can be performed while the CPU waits (or is blocked). Thus, the CPU can issue a memory read command that references the Flash memory portion of the address space, and wait until it receives the read data from the bus. (A similar process can take place when the CPU accesses actual internal memory, such as RAM 202). Thus, no interrupts need to be used and the CPU can receive and use the data immediately (without necessarily needing to save the data).

Blocking while waiting for data to arrive can be well suited for internal memory, because internal memory access is relatively fast. However, accessing an external Flash memory is significantly slower. Nevertheless, for some embodiments, it can be considered preferable for the CPU to wait in order to avoid the delays and difficulties associated with interruptions and related context switches. However, in other embodiments, an interrupt can be used to provide the results and the CPU need not wait for a Flash memory transaction to complete. In yet another set of embodiments, the CPU can use a delayed transaction. More specifically, the CPU can issue a read command and continue with execution of subsequent software, not waiting for the read command to be completed. After some time has elapsed, the CPU can poll the SPI interface for the results of the command, and retrieve them if it has completed. If it has not yet been completed, the CPU can poll again. The advanced SPI controller can place the results of the command (when they arrive from the Flash memory) in a local buffer, wait for a CPU poll and send the results to the CPU as a response to the poll.

The advanced SPI controller can be an application specific integrated circuit (ASIC) and can include custom hardware for performing the functions discussed above. Alternatively or in addition, the advanced SPI controller can include a microcontroller and a memory. The memory can include software (or firmware) for performing some or all of the functions discussed above. SPI interface 403 can include advanced SPI controller 408 in addition to the known structure of an existing SPI interface.

The CPU 201 of device 400 can execute software. The software can be included in the RAM 202, the ROM 205 or other storage (such as an optical disk, a hard drive, etc). The software can cause the CPU to perform various functions, such as accessing an external memory (e.g., Flash memory 220). Existing software for accessing external memory can be relatively complex as it requires programming an interface for communicating with the external memory, responding to interruptions, etc. (see detailed discussion above). However, software associated with the present invention can differ than the existing software in that it can include ordinary internal memory access instructions for accessing the external memory. The instructions can reference a portion of the address space that is associated with the external memory.

While the present invention was discussed in the context of external Flash memory, it is not limited to Flash memory but is applicable to other types of external memories (as discussed above). Furthermore, it can be applicable to internal memories that are not directly connected to a bus but are connected to the bus through an additional interface, such as a SPI interface. For the purposes of the present invention these memories can be referred to as external memories even if they are physically placed within electronic device 400. Embodiments of the present invention can also be applicable to various other storage devices such as, for example, hard disk drives.

Furthermore, the present invention is not only applicable to a SPI interface but may utilize other interfaces that are distinct from the main system bus 207.

Embodiments of the present invention can be implemented for various different devices, as discussed above. Thus the data of Flash memory can include various different types of data, such as photos, video, audio, mobile telephone phone books, computer programs, computer program data, etc. In some embodiments, the Flash memory can be used as main or virtual memory for device 400. Thus, the CPU can store and/or read instructions and data associated with its ordinary operation from the Flash memory. Thus, for some embodiments, device 400 need not feature internal RAM and/or ROM.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A method for accessing an external memory by a device, comprising:
defining an address space of memory of the device, the address space including a portion associated with an internal memory of the device and a portion associated with the external memory;
issuing an internal memory access command to an internal bus by a processor of the device, the internal memory access command including an address which is part of the portion of the address space associated with the external memory; and
receiving the internal memory access command at an interface controller;
communicating with an external memory by the interface controller to execute the internal memory access command,
wherein the internal memory access command is of a format used for internal memory access and differs from a format for commands utilized by the external memory.

2. The method of claim 1, further including:
converting the address of the internal memory access command to a different address associated with the external memory by the interface controller; and
sending the address associated with the external memory to the external memory by the interface controller.

3. The method of claim 1, further including:
generating one or more external memory access instructions based on the internal memory access command by the interface controller; and
sending the one or more external memory access instructions to the external memory by the interface controller.

4. The method of claim 1, further including:
receiving a result from the external memory by the interface controller; and
sending the result to the processor by the interface controller.

5. The method of claim 4, further including before sending the result to the processor, formatting the result in a format used for results of the internal memory by the interface controller.

6. The method of claim 1, wherein the external memory is Flash memory.

7. The method of claim 1, wherein the interface controller is an SPI interface.

8. A method for accessing an external memory by an interface controller attached to a device, the method comprising:
receiving an internal memory access command by the interface controller from a processor of the device over an internal system bus; and
communicating with an external memory by the interface controller to execute the internal memory access command,
wherein the internal memory access command is of a format used for internal memory access and differs from a format for commands utilized by the external memory.

9. The method of claim 8, wherein the internal memory access command includes an address which is part of a portion of an address space of the device, said portion being associated with the external memory.

10. The method of claim 9, further including:
converting the address of the internal memory access command to a different address associated with the external memory by the interface controller; and
sending the address associated with the external memory to the external memory by the interface controller.

11. The method of claim 8, further including:
generating one or more external memory access instructions based on the internal memory access command by the interface controller; and
sending the one or more external memory access instructions to the external memory by the interface controller.

12. A device comprising:
a processor;
an internal bus attached to the processor;
an internal memory attached to the bus;
an interface controller attached to the bus; and
an external memory attached to the interface controller,
wherein:
the processor is configured to issue an internal memory access command to the bus, the internal memory access command including an address which is part of a predefined portion of an address space of the device, the predefined portion being associated with the external memory;
the interface controller is configured to receive the internal memory access command and communicate with an external memory to execute the internal memory access command; and
the internal memory access command is of a format used for internal memory access and differs from a format for commands utilized by the external memory.

13. The device of claim 12, wherein the bus comprises a bus decoder configured to forward the internal memory access command from the processor to the interface controller based on the address.

14. The device of claim 12, wherein the interface controller is further configured to:
convert the address of the internal memory access command to a different address associated with the external memory; and
send the address associated with the external memory to the external memory.

15. The device of claim 12, wherein the interface controller is further configured to:
generate one or more external memory access instructions based on the internal memory access command; and
send the one or more external memory access instructions to the external memory.

16. The device of claim 12, wherein the interface controller is further configured to:
receive a result from the external memory; and
send the result to the processor over the bus.

17. The device of claim 16 wherein the interface controller is further configured to format the result in a format used for results of the internal memory before sending the result to the processor.

18. The device of claim 12, wherein the external memory is Flash memory.

19. The device of claim 12, wherein the interface controller is an SPI interface.

20. A mobile telephone comprising the device of claim 12.

21. A digital audio player comprising the device of claim 12.

22. A an interface controller configured for insertion within a device and attached to a processor of the device through an internal bus and to an external memory, the interface controller comprising electronic circuitry configured to:
receive an internal memory access command from the processor over the internal bus; and
communicate with the external memory to execute the internal memory access command,
wherein the internal memory access command is of a format used for internal memory access by the processor and differs from a format for commands utilized by the external memory.

23. The interface controller of claim 22, wherein the circuitry is further configured to:
generate one or more external memory access instructions based on the internal memory access command; and
send the one or more external memory access instructions to the external memory.

24. A computer readable medium comprising a software for execution at a device, the software being configured to access an external memory connected to the device, the software comprising an internal memory access command which includes an address which is part of a predefined portion of an address space of the device, the predefined portion being associated with the external memory,
wherein the internal memory access command is of a format associated with the internal memory of the device and differs from a format for commands utilized by the external memory.

25. The computer readable medium of claim 24, wherein the internal memory access command is used to access the external memory and the software does not include specific instructions for programming an interface controller connected to the external memory.

26. A mobile telephone comprising:
a processor;
an internal bus attached to the processor;
an internal memory attached to the bus;
an interface controller attached to the bus; and
an external memory attached to the interface controller,
wherein:
the processor is configured to issue an internal memory access command to the bus, the internal memory access command including an address which is part of a predefined portion of an address space of the mobile telephone, the predefined portion being associated with the external memory;
the interface controller is configured to receive the internal memory access command and communicate with an external memory to execute the internal memory access command; and
the internal memory access command is of a format used for internal memory access and differs from a format for commands utilized by the external memory.

27. A digital audio player comprising:
a processor;
an internal bus attached to the processor;
an internal memory attached to the bus;
an interface controller attached to the bus; and
an external memory attached to the interface controller,
wherein:
the processor is configured to issue an internal memory access command to the bus, the internal memory access command including an address which is part of a predefined portion of an address space of the digital audio player, the predefined portion being associated with the external memory;
the interface controller is configured to receive the internal memory access command and communicate with an external memory to execute the internal memory access command; and
the internal memory access command is of a format used for internal memory access and differs from a format for commands utilized by the external memory.
